(19) United States
(12) Patent Application Publication
(10) Pub. No.: US 2020/0190240 A1
(43) Pub. Date: Jun. 18, 2020

(54) Polymer Polyol and Photochromic Coating Composition Thereof

(71) Applicant: Shanghai Gantian Optical Materials Co., Ltd., Shanghai (CN)

(72) Inventor: Jiaan Gan, Shanghai (CN)

(21) Appl. No.: 16/619,833

(22) PCT Filed: Jan. 23, 2018
(86) PCT No.: PCT/CN2018/073738

§ 371 Date: Dec. 5, 2019

(30) Foreign Application Priority Data
Jun. 6, 2017 (CN) 201710420572.9

(51) Int. Cl. C08F 220/20; C08L 75/04; C08G 18/75; C08G 18/73; C08G 18/76; C08G 77/442; C08G 77/08; C08G 18/62; C08F 220/14; C08K 5/1545; C08K 5/23; G02B 5/23; G02B 1/04

(52) U.S. Cl. CPC C08F 220/20; C08L 75/04; C08G 18/755; C08G 18/73; C08G 18/7642; C08G 18/758; G02B 1/04; C08G 77/08; C08G 18/6229; C08F 220/14; C08K 5/1545; C08K 5/23; G02B 5/23; C08G 77/442

(57) ABSTRACT

The present invention provides a polymer-polyol and its composition for producing photochromic coating products. The polymer-polyol is prepared by copolymerization of acrylate concluding hydroxy or not. The composition includes: (i) matrix resin; (ii) polymer-polyol mentioned above; and (iii) photochromic compound. And the solid content of the hydroxyl group in the composition is about 1.0%-6.0%. The composition has good compatibility with other functional coatings, such as unique organosilane hard coating and/or antireflective coating. It is appropriate for preparing the photochromic coating products which can be used in the ophthalmology field.

### CROSS-REFERENCE TO RELATED APPLICATION

This application is a national stage application of application PCT/CN2018/073738, filed on Jan. 23, 2018, which claims the benefit of China Patent Application No. 201710420572.9, filed on Jun. 6, 2017, in the State Intellectual Property Office of the People's Republic of China, the disclosure of which is incorporated herein in its entirety by reference.

### BACKGROUND OF THE INVENTION

### 1. Field of the Invention

The present invention relates to a polymer-polyol and its composition for producing photochromic coating products, processes for the composition and photochromic coating products produced using the compositions and/or processes.

### 2. Description of the Related Art

The method that paints coatings containing photochromic compounds on the transparent plastic to set a photochromic layer is called coating method. Theoretically, optical lens can be simply given photochromic properties through this method. Because of no limit to the lens substrate, this method has been rapidly developed.

When photochromic coating is applied to the surface of a plastic substrate, it will possibly cause scratches or other similar defects due to the physical contact like cleaning or contacting with the external environment. In some cases, the manufacturers have to use detergents which contained alcohol such as ethanol, isopropanol to clean the surface of coating. And the photochromic coating may be damaged through the process of cleaning. Therefore, it is necessary to paint wear-resistant coating above it. However, during the producing process of the photochromic lenses, it is general that the wear-resistant coating or the antireflective coating painted above it cannot meet the requirements or commercial criterions of ophthalmic lenses. The defects of the coated lenses include spots, scratches, impurities, ripples, cracks, etc. When these defects exist, it is an economic and effective way to use sodium hydroxide aqueous solution or detergents which contained that to remove the organosilane hard coating and paint a new one. However, in the removal the defective organosilane hard coating, it may damage the photochromic layer under the organosilane hard coating results in the loss of commercial value of products. The painting of organosilane hard coating and antireflective coating is the end of the manufacturing steps. Every step added in the production process will lead additional value and extra cost. If the coating cannot meet the requirements which leads to the waste of lenses, the manufacturing cost will be greatly increased and the profit will be reduced, which finally causes great economic losses to the manufactures.

In addition, some photochromic lens manufacturers need to paint their own special organosilane hard coating and antireflective coating on the photochromic coating they bought from other manufactures. During the process of packaging, transporting, unpacking, cleaning, scrubbing, etc., it may cause the scratches, tarnishes or corrosion to the photochromic layer. Thus, the properties of scratch resistance and corrosion resistance are necessary.

In conclusion, there is an urgent need to invent one kind of photochromic coating which has good weather resistance and good compatibility with other functional coatings, such as unique organosilane hard coatings and antireflective coatings. Therefore, this is a technical problem to be solved in this invention.

### SUMMARY OF THE INVENTION

The present invention arises from our finding that the thermosetting photochromic composition which has high intensity, high curing velocity and good achromatizing capability can be obtained, upon addition of one polymer-polyol which has a mixing uniformity of soft groups and hard groups into the thermosetting photochromic composition. Applying the same technique into the thermosetting coating painted on the photochromic layer, it is possible to get one new type of photochromic product which has high intensity, high curing velocity, good achromatizing capability, good weather resistance, good scratch resistance and good close adaptation between coatings. Thereby, the flaws of the existing technology can be overcame.

The present invention provides a neoteric polymer-polyol/copolymer. The main producing steps of it are as follows:

Under an inert gas atmosphere, compound I, II, III are mixed at a mass ratio of (0.5 to 2.0): 1:1 with initiator. The mixture is heated at 110° C.-150° C. for 2-3 hours to carry out the polymerization, and the resulting copolymer is target product, namely, polymer-polyol.

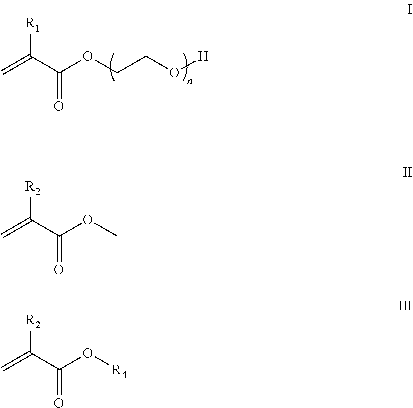

wherein R₁, R₂, R₃ are a hydrogen atom or straight/branched alkyl group whose carbon number is selected from the group consisting of 1 to 4; R₄ is a straight/branched alkyl group whose carbon number is selected from the group consisting of 4 to 6; n is an integer selected from the group consisting of 1 to 5.

The present invention also provides one kind of thermosetting photochromic composition. The composition includes:

(i) matrix resin,

(ii) polymer-polyol mentioned above,

(iii) photochromic compound.

And the solid content of hydroxyl in the composition is 1.0%-6.0%.

The matrix resin mainly includes: (i) polyurethane, (ii) hydroxy acrylic resin, (iii) amino resin or/and organic silicone resin.

The polyurethane is chosen one or more kinds from polyurethane which was blocked by hexamethylene diisocyanate (HDI), isophorone diisocyanate (IPDI), xylylene diisocyanate (XDI), dicyclohexylmethylmethane-4,4′-diisocyanate (H12MDI), toluene diisocyanate (TDI) or diphenylmethane diisocyanate (MDI).

The photochromic compounds are chosen one or more kinds from naphthopyran-based, phenanthropyran-based, benzopyran-based, indenopyran-based, spiropyrane-based, fulgide-based or diarylethene-based photochromic compounds.

The main producing steps of organic silicone resin are as follows:

Take 10 to 30 parts by weight of polymer-polyol mentioned above, 5 to 30 parts by weight of silane, 5 to 20 parts by weight of alkyl orthosilicate, 15 to 50 parts by weight of silane coupling agent, 0.5 to 1.0 parts by weight of catalyst, 10 to 30 parts by weight of alcoholic solvents, 5 to 20 parts by weight of water into the reactor, and react at 25° C.-50° C. for 2-5 hours. After removing all the alcoholic solvents and water by evaporating, the remnant is the organic silicone resin this invention described.

The following formula IV shows the structure of silane mentioned above:

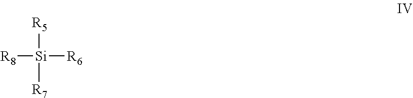

wherein R₅, R₆, R₇, R₈ are a straight/branched alkyl group or alkoxy group whose carbon number is selected from the group consisting of 1 to 4; and at least one of them is alkoxy group.

The catalyst mentioned above is aluminum acetylacetonate or hydrochloric acid.

The alcoholic solvents are chosen one or more kinds from unitary aliphatic alcohol, whose carbon number is selected from the group consisting of 1 to 4.

All the components of the thermosetting photochromic composition mentioned above are bought from manufacturers, except the polymer-polyol and the organic silicone resin.

The present invention also provides a concrete purpose of the polymer-polyol and thermosetting photochromic composition mentioned above: the application in the preparation of the photochromic coating products which can be used in the ophthalmology field.

### DETAILED DESCRIPTION OF THE PREFERRED EMBODIMENTS

One of the optimized example in this present invention is that: R₁, R₂, R₃ is chosen from hydrogen atom or methyl respectively, and R₄ is chosen from straight or branched alkyl group whose carbon number is selected from the group consisting of 4 to 6.

The more optimized example is that: R₁ is a hydrogen atom; R₂ and R₃ are both methyl group; R₄ is n-butyl group.

In another optimized example of this present invention, the main producing steps of the polymer-polyol are as follows:

Under a nitrogen atmosphere, compound I, II, III are mixed at a mass ratio (0.5 to 2.0): 1:1 with 2,2′-Azobisisoheptonitrile. The mixture is heated at 110° C.-150° C. (the optimized temperature is 130° C.-140° C.) for 2-3 hours in the diethylene glycol monobutyl ether to polymerize, and the resulting copolymer is the polymer-polyol this invention described.

In another optimized example of this present invention provides one kind of thermosetting photochromic composition. The composition includes: matrix resin, polymer-polyol mentioned above, photochromic compound and other accessory ingredients. The solid content of hydroxy is about 1.3%-3.5%, and the mass ratio of the matrix resin and polymer-polyol is about 1:(0.5 to 5.0).

In another optimized example of this present invention, the matrix resin used in the thermosetting photochromic composition can be chosen from: (i) the composition of polyurethane (the polyurethane which blocked by ethyl methyl ketone oxime is optimized) and hydroxy acrylic resin; (ii) amino resin (including Cymel 303LF and/or partly alkylated amino resin); (iii) organic silicone resin (own product); (iv) the composition of the resins mentioned above (the composition of polyurethane (the polyurethane which blocked by ethyl methyl ketone oxime is optimized), hydroxy acrylic resin, amino resin and organic silicone resin).

In another optimized example of this present invention, R₅, R₆, R₇, R₈ is respectively chosen from: methyl, ethyl, n-propyl, isopropyl, n-butyl, isobutyl, vinyl, propenyl, butenyl, methoxy, ethoxy, propoxy or butoxy. And there is at least one chosen from methoxy, ethoxy, propoxy or butoxy.

In another optimized example of this present invention, the alkyl orthosilicate which used to prepare organic silicone resin can be methyl orthosilicate, ethyl orthosilicate, n-propyl orthosilicate or n-butyl orthosilicate.

In another optimized example of this present invention, the accessory ingredient in the thermosetting photochromic composition includes light stabilizer, surfactant and aprotic polar solvent. The light stabilizer can be the one which is conventionally used for photochromic coating products in the ophthalmology field. The surfactant can be cationic surfactant, anionic surfactant or nonionic surfactant (such as the polyether modified organic silicon surfactant V-2245).

The present invention is further illustrated by the following examples, and the purpose of which is merely to lead a better understanding of the present invention. Accordingly, the examples given herein are not intended to limit the scope of the invention.

### The Preparation of Polymer-Polyol

### Example 1

The 29.5% weight of I_{A}, 25% weight of II_{A}, 25% weight of III_{A}, 20% weight of diethylene glycol monobutyl ether, 0.5% weight of initiator were placed into the reactor which had the function of stirring and heating.

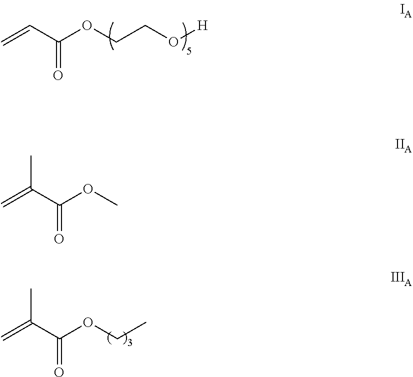

The composition was prepared as described below:

| Preparation | |
|---|---|
| Step | Preparation Program |
| Step 1 | Place the composition into the reactor. |
| Step 2 | Aerate nitrogen into the reactor. |
| Step 3 | Start stirring and heating. |
| Step 4 | Add 2,2′-Azobisisoheptonitrile dropwise. |
| Step 5 | Heat at 130° C.-140° C. for 2-3 hours. |
| Step 6 | Cool down to the room temperature. |
| Step 7 | Evaporate all the solvent. |
| Step 8 | The remnant is the target product (Polymer-polyol-1). |

### Example 2

The 24.5% weight of I_{A}, 27.5% weight of II_{A}, 27.5% weight of III_{A}, 20% weight of diethylene glycol monobutyl ether, 0.5% weight of initiator was placed into the reactor which had the function of stirring and heating.

| Preparation | |
|---|---|
| Step | Preparation Program |
| Step 1 | Place the composition into the reactor. |
| Step 2 | Aerate nitrogen into the reactor. |
| Step 3 | Start stirring and heating. |
| Step 4 | Add 2.2′-Azobisisoheptonitrile dropwise. |
| Step 5 | Heat at 130° C.-140° C. for 2-3 hours. |
| Step 6 | Cool down to the room temperature. |
| Step 7 | Evaporate all the solvent. |
| Step 8 | The remnant is the target product (Polymer-polyol-2). |

### The Preparation of Organic Silicone Resine (OSEM)

### Example 3

The 15 parts by weight of Polymer-polyol-1, 15 parts by weight of methyl triethoxysilane, 15 parts by weight of ethyl orthosilicate, 25 parts by weight of KH560, 3 parts by weight of KH550, 6.5 parts by weight of vinyl trimethoxy silane, 10 parts by weight of the composition of isometric methanol and tert-butanol, 10 parts by weight of water and 0.5 parts by weight of aluminum acetylacetonate were placed into the reactor which had the function of stirring and heating.

| Preparation | |
|---|---|
| Step | Preparation Program |
| Step 1 | Place the composition into the reactor. |
| Step 2 | Aerate nitrogen into the reactor. |
| Step 3 | Start stirring and heating. |
| Step 4 | Heat at 40° C.-50° C. for 3-5 hours. |
| Step 5 | Evaporate alcoholic solvent and water in vacuo. |
| Step 6 | The remnant is the target product (OSEM-A). |

### Example 4

The 15 parts by weight of Polymer-polyol-2, 20 parts by weight of methyl triethoxysilane, 10 parts by weight of ethyl orthosilicate, 20 parts by weight of KH560, 8 parts by weight of KH550, 6.5 parts by weight of vinyl trimethoxy silane, 10 parts by weight of the composition of isometric methanol and tert-butanol, 10 parts by weight of water and 0.5 parts by weight of 0.1N hydrochloric acid was placed into the reactor which had the function of stirring and heating.

| Preparation | |
|---|---|
| Step | Preparation Program |
| Step 1 | Place the composition into the reactor. |
| Step 2 | Aerate nitrogen into the reactor. |
| Step 3 | Start stirring and heating. |
| Step 4 | Heat at 40° C.-50° C. for 3-5 hours. |
| Step 5 | Evaporate alcoholic solvent and water in vacuo. |
| Step 6 | The remnant is the target product (OSEM-B). |

### The Preparation of Photochromic Composition

### Example 5 to 15

The photochromic composition can be prepared by mixing all the components homogeneously at 60° C. The specific information was supplied in Table 1.

TABLE 1

| | | Parts | Abbrevia- |
|---|---|---|---|
| Number | Components | (wt %) | tion |
| Exam- | HDI blocked by ethyl methyl ketone | 28 | Composi- |
| ple 5 | oxime (Bayer) | | tion A |
| | IPDI blocked by ethyl methyl ketone | 20 | |
| | oxime (Bayer) | | |
| | Polymer-polyol-1 | 18 | |
| | Hydroxy acrylic resin (Bayer) | 5 | |
| | Poly(hexanyl carbonatediol) | 5 | |
| | 2,2′-Bis(4-methoxyphenyl)-2,7-dihydro- | 5 | |
| | pyran | | |
| | [3,2-c]carbazole | | |
| | N-methyl pyrrolidone | 17 | |
| | Light stabilizer 770 | 0.5 | |
| | Dibutyltin dilaurate (catalyst) | 0.5 | |
| | Polyether modified organic silicon | 1 | |
| | surfactant V-2245 | | |
| Exam- | HDI blocked by ethyl methyl ketone | 25 | Composi- |
| ple 6 | oxime (Bayer) | | tion B |
| | IPDI blocked by ethyl methyl ketone | 22 | |
| | oxime (Bayer) | | |
| | Polymer-polyol-1 | 17 | |
| | Hydroxy acrylic resin (Bayer) | 5 | |
| | Poly(hexanyl carbonatediol) | 5 | |
| | 2,2′-Bis(4-methoxyphenyl)-2,7-dihydro- | 5 | |
| | pyran [3,2-c]carbazole | | |
| | N-methyl pyrrolidone | 18 | |
| | Light stabilizer 770 | 0.5 | |
| | Dibutyltin dilaurate (catalyst) | 0.5 | |
| | Polyether modified organic silicon | 1 | |
| | surfactant V-2245 | | |
| Exam- | HDI blocked by ethyl methyl ketone | 13 | Composi- |
| ple 7 | oxime (Bayer) | | tion C |
| | IPDI blocked by ethyl methyl ketone | 12 | |
| | oxime (Bayer) | | |
| | Polymer-polyol-1 | 23 | |
| | Hydroxy acrylic resin (Bayer) | 12 | |
| | Poly(hexanyl carbonatediol) | 5 | |
| | 2,2′-Bis(4-methoxyphenyl)-2,7-dihydro- | 5 | |
| | pyran [3,2-c]carbazole | | |
| | N-methyl pyrrolidone | 18 | |
| | Light stabilizer 770 | 0.5 | |
| | Dibutyltin dilaurate (catalyst) | 0.5 | |
| | KH550 | 10 | |
| | Polyether modified organic silicon | 1 | |
| | surfactant V-2245 | | |
| Exam- | OSEM-A | 43 | Composi- |
| ple 8 | Polyester polyol CAPA2200 (Perstorp) | 15 | tion D |
| | Poly(hexanyl carbonatediol) | 15 | |
| | 2,2′-Bis(4-methoxyphenyl)-2,7-dihydro- | 5 | |
| | pyran [3,2-c]carbazole | | |
| | Aluminum acetylacetonate | 1 | |
| | N-methyl pyrrolidone | 18 | |
| | Light stabilizer 770 | 0.5 | |
| | KH560 | 2 | |
| | Polyether modified organic silicon | 0.5 | |
| | surfactant V-2245 | | |
| Exam- | OSEM-B | 42 | Composi- |
| ple 9 | Polyester polyol CAPA2200 (Perstorp) | 15 | tion E |
| | Poly(hexanyl carbonatediol) | 15 | |
| | 2,2'-Bis (4-methoxyphenyl)-2,7-dihydro- | 5 | |
| | pyran [3,2-c]carbazole | | |
| | Aluminum acetylacetonate | 1 | |
| | N-methyl pyrrolidone | 19 | |
| | Light stabilizer 770 | 0.5 | |
| | KH560 | 2 | |
| | Polyether modified organic silicon | 0.5 | |
| | surfactant V-2245 | | |
| Exam- | OSEM-A | 42 | Composi- |
| ple 10 | Polyester polyol CAPA2200 (Perstorp) | 15 | tion F |
| | Poly(hexanyl carbonatediol) | 16 | |
| | 2,2′-Bis(4-methoxyplenyl)-2,7-diliydro- | 5 | |
| | pyran [3,2-c]carbazole | | |
| | Aluminum acetylacetonate | 1 | |
| | N-methyl pyrrolidone | 18 | |
| | Light stabilizer 770 | 0.5 | |
| | KH560 | 2 | |
| | Polyether modified organic silicon | 0.5 | |
| | surfactant V-2245 | | |
| Exam- | Cymel 1158 (Cytex) | 35.5 | Composi- |
| ple 11 | Polymer-polyol-2 | 30 | tion G |
| | Hydroxy acrylic resin (Bayer) | 7 | |
| | Poly(hexanyl carbonatediol) | 5 | |
| | 2,2′-Bis(4-methoxyphenyl)-2,7-dihydro- | 5 | |
| | pyran [3,2-c]carbazole | | |
| | N-methyl pyrrolidone | 15 | |
| | Light stabilizer 770 | 1 | |
| | P-toluenesulfonic acid | 1 | |
| | Polyether modified organic silicon | 0.5 | |
| | surfactant V-2245 | | |
| Exam- | Cymel 1158 (Cytex) | 30 | Composi- |
| ple 12 | Polymer-polyol-2 | 35.5 | tion H |
| | Hydroxy acrylic resin (Bayer) | 5 | |
| | Poly(hexanyl carbonatediol) | 7 | |
| | 2,2′-Bis(4-methoxyphenyl)-2,7-dihydro- | 5 | |
| | pyran [3,2-c]carbazole | | |
| | N-methyl pyrrolidone | 15 | |
| | Light stabilizer 770 | 1 | |
| | P-toluenesulfonic acid | 1 | |
| | Polyether modified organic silicon | 0.5 | |
| | surfactant V-2245 | | |
| Exam- | HDI blocked by ethyl methyl ketone | 8 | Composi- |
| ple 13 | oxime (Bayer) | | tion I |
| | IPDI blocked by ethyl methyl ketone | 7 | |
| | oxime (Bayer) | | |
| | OSEM-B | 15 | |
| | Cymel 1158 (Cytex) | 15 | |
| | Polymer-polyol-2 | 19.5 | |
| | Hydroxy acrylic resin (Bayer) | 5 | |
| | Poly(hexanyl carbonatediol) | 5 | |
| | 2,2′-Bis(4-methoxyphenyl)-2,7-dihydro- | 5 | |
| | pyran [3,2-c]carbazole | | |
| | N-methyl pyrrolidone | 18 | |
| | Light stabilizer 770 | 1 | |
| | P-toluenesulfonic acid | 0.5 | |
| | Polyether modified organic silicon | 1 | |
| | surfactant V-2245 | | |
| Exam- | HDI blocked by ethyl methyl ketone | 8 | Composi- |
| ple 14 | oxime (Bayer) | | tion J |
| | IPDI blocked by ethyl methyl ketone | 7 | |
| | oxime (Bayer) | | |
| | OSEM-A | 5 | |
| | Cymel 1158 (Cytex) | 15 | |
| | Polymer-polyol-2 | 32.5 | |
| | Hydroxy acrylic resin (Bayer) | 2 | |
| | Poly(hexanyl carbonatediol) | 5 | |
| | 2,2′-Bis(4-methoxyphenyl)-2,7-dihydro- | 5 | |
| | pyran [3,2-c]carbazole | | |
| | N-methyl pyrrolidone | 18 | |
| | Light stabilizer 770 | 1 | |
| | P-toluenesulfonic acid | 0.5 | |
| | Polyether modified organic silicon | 1 | |
| | surfactant V-2245 | | |
| Exam- | HDI blocked by ethyl methyl ketone | 13 | Composi- |
| ple 15 | oxime (Bayer) | | tion K |
| | IPDI blocked by ethyl methyl ketone | 12 | |
| | oxime (Bayer) | | |
| | OSEM-B | 5 | |
| | Cymel 1158 (Cytex) | 5 | |
| | Polymer-polyol-2 | 32.5 | |
| | Hydroxy acrylic resin (Bayer) | 2 | |
| | Poly(hexanyl carbonatediol) | 5 | |
| | 2,2′-Bis(4-methoxyphenyl)-2,7-dihydro- | 5 | |
| | pyran [3,2-c]carbazole | | |
| | N-methyl pyrrolidone | 18 | |
| | Light stabilizer 770 | 1 | |
| | P-toluenesulfonic acid | 1 | |
| | Polyether modified organic silicon | 0.5 | |
| | surfactant V-2245 | | |

### The Preparation and Functional Test of Photochromic Coating Products

### Example 16

(1) The preparatory steps of the lenses.

In the following tests, semi-finished plano optical lenses made by Makrolon was used. And the preparatory works of the lenses were as follows:

| Preparatory | |
|---|---|
| Step | Preparatory Program |
| Step 1 | Etch the lenses with 12% sodium hydroxide |
| | solution at 60° C. for 10 minutes. |
| Step 2 | Clean the lenses with deionized water. |
| Step 3 | Wash the lenses with tepid suds. |
| Step 4 | Clean the lenses with deionized water. |
| Step 5 | Dry the lenses in vacuo. |

(2) The surface drying time measurement of the photochromic coating.

The photochromic composition A to K was painted onto the plasma-prepared lenses respectively by spin-coating method, and cured them thermally. Meanwhile, the surface drying time was measured. The specific steps were as follows:

| Preparation | |
|---|---|
| Step | Preparation Program |
| Step 1 | Mix the components of composition A to K at 60° C. for |
| | 30 minutes respectively. |
| Step 2 | Mix the composition at room temperature for 60 minutes. |
| | Paint the composition onto the lenses by spin-coating |
| Step 3 | method. And the thickness of the photochromic coatings |
| | is about 20 micrometers. |
| Step 4 | Bake the lenses at 120° C. for 60 minutes. |
| Step 5 | Measure the surface drying time at room temperature |
| | (about 15° C. to 25° C.).The results are shown in Table 2. |

(3) The surface drying time measurement of the adhesive layer.

The Tires 2854 Resin (Nuplex Resin Co., Ltd. produced) was painted onto the thermosetting photochromic coating by spin-coating method, and cured them thermally. In the meanwhile, we measured the surface drying time. The specific steps were as follows:

| Preparation | |
|---|---|
| Step | Preparation Program |
| Step 1 | Paint the resin onto the lenses by |
| | spin-coating method. |
| Step 2 | Bake the lenses at 120° C. for 60 minutes. |
| Step 3 | Measure the surface drying time at room |
| | temperature (about 15° C. to 25° C.).The |
| | results are shown in Table 2. |

(4) The functional test of the products after painting the hard coatings.

Firstly, the lenses was placed which were painted the thermosetting photochromic coating into the 10% sodium hydroxide solution at 60° C. for at least 5 minutes. After that, the damage in visual inspection did not occur.

Secondly, the adhesive force was tested between the lenses and the thermosetting coating by peeling test, and most of them were up to standard (refer to Table 2).

Thirdly, the Bayer abrasion test and steel wool fraction test were performed. The results are shown in Table 2.

To further enhance the scratch resistance of lenses, we painted antifraying hard coating which was based on siloxane (thermosetting acrylic resin 1757, Nuplex Resin Co., Ltd. produced) onto the thermosetting coating. The specific steps were as follows:

| Preparation and | |
|---|---|
| Test Step | Preparation and Test Program |
| Step 1 | Pretreat the lenses by plasma processing for 5 minutes. |
| Step 2 | Paint the antifraying hard coating onto the lenses. |
| Step 3 | Heat to 100° C. for 3 hours to solidify. |
| Step 4 | After the lenses surface forcing at 10 N/mm² for 15 |
| | seconds, measure the hardness at the depth of 2 |
| | micrometers.* |

*(i) Test with Fisherscope HCV (H-100); (ii). After testing 3 to 5 times of each lens, take the average data (refer to Table 2).

(5) The crazing temperature test of the antireflective coating.

The products were placed which were painted the antireflective coating into the oven. Then heat up to 50° C. for 1 hour. After cooling down to room temperature, check for capillary crack. If there were no cracks, the oven temperature was increased by 10° C. and repeated the process above until the coating cracks. And the temperature was called crazing temperature.

The antireflective coating (DON CO., LTD. produced) was painted onto a blank control lens and the lenses which were painted the composition A to K according to the method mentioned above. Then the crazing temperature was measured respectively. The specific results were shown in Table 2.

(6) The measurement of chromophoric concentration and half-time of fading.

The lenses were illuminated which were painted the composition A to K with 365 nm ultraviolet light emitted by the xenon lamp (L-2480(300 w)SHL-100) through the aero mass filter at room temperature for 180 seconds to display color. Then the maximum absorption wavelength was measured by spectrophotometer. The chromophoric concentration was about ε(140)-ε(0)=1.0. This was just a reference value. The chromophoric concentration can be determined around 1.0. The results were shown in Table 2.

After illuminating the lenses for 140 seconds, the maximum absorption wavelength will decline to the half of the ε(140)-ε(0) value. The time it required was called the half-time of fading. The time was measured respectively, and the results shown in the Table 2.

(7) The endurance quality test of the samples.

The xenotestapparatus (Wu Xi City Su Rui Experimental Equipment CO., LTD. produced) was used accelerating the aging of samples at 70° C. for 48 hours. The chromophoric concentration of the samples was measured before and after the test, recorded as A₀ and A₂₀₀. The repeat residual rate which expresses the endurance quality can be calculated by the following equation:

Repeat Residual Rate (%)=(A₂₀₀/A₀)×100%

The specific data and the yellow quota which can be measured by Cary 4000 are shown in Table 2

TABLE 2

| | Surface drying time | | | | Hardness of |
|---|---|---|---|---|---|
| | of the photochromic | Surface drying time | The Bayer abrasion | The result of | the hard |
| | coating | of the adhesive layer | ratio of the product | the peeling | coating surface |
| Number | (s) | (s) | without hard coating | test | (N/mm²) |
| A | 910 | 200 | 0.55 | Qualified | 30 |
| B | 890 | 190 | 0.73 | Disqualified | 46 |
| C | 880 | 150 | 0.68 | Qualified | 45 |
| D | 680 | 160 | 0.75 | Qualified | 47 |
| E | 680 | 170 | 0.50 | Qualified | 38 |
| F | 680 | 160 | 0.55 | Qualified | 45 |
| G | 230 | 140 | 0.62 | Qualified | 46 |
| H | 240 | 140 | 0.80 | Disqualified | 59 |
| I | 260 | 150 | 0.75 | Qualified | 55 |
| J | 260 | 150 | 0.70 | Qualified | 50 |
| K | 250 | 160 | 0.76 | Qualified | 55 |
| CE* | — | — | — | Qualified | 62 |

| | Crazing | Crazing | Photochromic character | | | |
|---|---|---|---|---|---|---|
| | temperature without | temperature with | | Half-time | Repeat | Yellow |
| | the adhesive layer | the adhesive layer | Chromophoric | of fading | residual rate | quota |
| Number | (° C.) | (° C.) | concentration | (s) | (%) | (YI) |
| A | 45 | 60 | 0.9 | 168 | 83 | 2.8 |
| B | 55 | 70 | 0.85 | 183 | 82 | 2.4 |
| C | 60 | 70 | 1.0 | 155 | 80 | 1.8 |
| D | 58 | 65 | 1.0 | 138 | 81 | 1.9 |
| E | 50 | 60 | 1.0 | 139 | 85 | 2.2 |
| F | 55 | 60 | 0.98 | 125 | 86 | 2.3 |
| G | 60 | 60 | 0.85 | 135 | 83 | 2.4 |
| H | 60 | 75 | 0.89 | 165 | 87 | 2.0 |
| I | 55 | 65 | 1.0 | 135 | 86 | 1.9 |
| J | 50 | 70 | 1.1 | 125 | 88 | 1.9 |
| K | 55 | 70 | 1.2 | 115 | 89 | 1.8 |
| CE* | --70 | 70 | 1.0 | 145 | 88 | 2.1 |

*CE is the contrast which can be sold as a qualified product. The preparation steps are as follows:

| Preparatory | |
|---|---|
| Step | Preparatory Program |
| Step 1 | Put 40 mg naphthopyran allochroic powder, 74 g bisphenol |
| | A ethoxylate dimethacrylate, 20 g polyethylene glycol, 600 |
| | g dimethacrylate, 6 g dipoly-α-methylstyrene in the flask. |
| Step 2 | After heating to dissolve, cool down to the room tempera- |
| | ture. |
| Step 3 | Add 0.23 g 2,2′-Azobisisoheptonitrile and mix. |
| Step 4 | Clean the lenses with deionized water. |
| Step 5 | Pour the composition into the glass mold (diameter is 70 |
| | mm) of round plano lens for 2 mm thickness. |
| Step 6 | Seal the mold and place into the program controlled oven |
| | whose air flow is horizontal. |
| Step 7 | Set the oven heating up from 35° C. to 100° C. in 18 hours, |
| | and keep 100° C. for 2 hours. |
| Step 8 | Open the mold. Place the lenses into oven at 110° C. for 2 |
| | hours to solidify. |
| Step 9 | Wash the lenses, paint the antifraying hard coating and |
| | antireflective coating through the method mentioned above. |

Table 2 shown the characters which the photochromic coating made from the thermosetting photochromic composition provided by this present invention has, such as the higher Bayer abrasion ratio, higher surface hardness, higher crazing temperature, higher chromophoric concentration, higher repeat residual rate, smaller yellow quota and shorter fading half-time.

In conclusion, the thermosetting photochromic composition provided by this present invention has good compatibility with other functional coatings, such as organosilane hard coating and/or antireflective coating. They are appropriate for preparing the photochromic coating products which can be used in the ophthalmology field.

1. The present invention provides a neoteric polymer-polyol/copolymer. The main producing steps of it are as follows:
Under an inert gas atmosphere, compound I, II, III are mixed at a mass ratio of (0.5 to 2.0): 1:1 with initiator. The mixture is heated at 110° C.-150° C. for 2-3 hours to polymerize, and the resulting copolymer is the target product, which is the polymer-polyol this invention described. 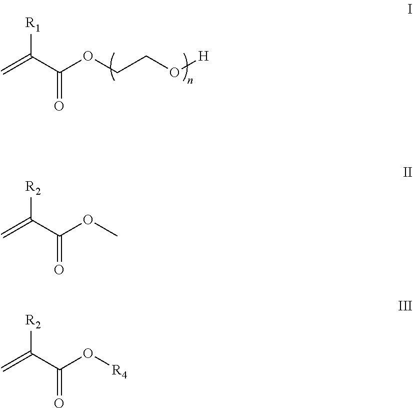
wherein R₁ is hydrogen atom or straight/branched alkyl group whose carbon number is selected from the group consisting of 2 to 5; R₂, R₃ are a hydrogen atom or straight/branched alkyl group whose carbon number is selected from the group consisting of 1 to 4; R₄ is straight/branched alkyl group whose carbon number is selected from the group consisting of 4 to 10.

2. A composition according to claim 1, wherein R₁, R₂, R₃ are chosen from hydrogen atom or methyl respectively, and R₄ is chosen from straight/branched alkyl group whose carbon number is selected from the group consisting of 4 to 6.

3. A composition according to claim 2, wherein R₁ is a hydrogen atom; R₂ and R₃ are both methyl group; R₄ is n-butyl group.

4. A composition according to claims 1 to 3, wherein the initiator is 2,2′-Azobisisoheptonitrile.

5. The present invention provides one kind of thermosetting photochromic composition. The composition includes: matrix resin, polymer-polyol according to claims 1 to 4, photochromic compound. And the solid content of hydroxy is about 1.0%-6.0%.
The photochromic compounds are chosen one or more kinds from naphthopyran-based, phenanthropyran-based, benzopyran-based, indenopyran-based, spiropyrane-based, fulgide-based or diarylethene-based photochromic compounds.

6. A composition according to claim 5, wherein the mass ratio of the matrix resin and polymer-polyol according to claims 1 to 4 is about 1:(0.5 to 5.0).

7. A composition according to claims 5 and 6, wherein the matrix resin mainly includes: polyurethane, hydroxy acrylic resin, amino resin or/and organic silicone resin.
The polyurethane is chosen one or more kinds from polyurethane which was blocked by hexamethylene diisocyanate, isophorone diisocyanate, xylylene diisocyanate, dicyclohexylmethylmethane-4,4′-diisocyanate, toluene diisocyanate or diphenylmethane diisocyanate.
The main producing steps of organic silicone resin are as follows:
Take 10 to 30 parts by weight of polymer-polyol mentioned above, 5 to 30 parts by weight of silane, 5 to 20 parts by weight of alkyl orthosilicate, 15 to 50 parts by weight of silane coupling agent, 0.5 to 1.0 parts by weight of catalyst, 10 to 30 parts by weight of alcoholic solvents, 5 to 20 parts by weight of water into the reactor, and react for 2-5 hours at 25° C.-50° C. After removing all the alcoholic solvents and water by evaporating, the remnant is the organic silicone resin this invention described.
The following formula IV shows the structure of silane mentioned above: 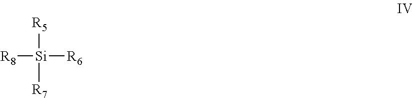
wherein R₅, R₆, R₇, R₈ are alkyl group or alkoxy group whose carbon number is selected from the group consisting of 1 to 4; and at least one of them is alkoxy group.
The catalyst mentioned above is aluminum acetylacetonate or hydrochloric acid.
The alcoholic solvents are chosen one or more kinds from unitary aliphatic alcohol, whose carbon number is selected from the group consisting of 1 to 4.

8. A composition according to claim 7, wherein the polyurethane is chosen one or more kinds from polyurethane which was blocked by hexamethylene diisocyanate, isophorone diisocyanate, xylylene diisocyanate, dicyclohexylmethylmethane-4,4′-diisocyanate, toluene diisocyanate or diphenylmethane diisocyanate, and the end-capping reagent is ethyl methyl ketone oxime.

9. A polymer-polyol according to claims 1 to 4, wherein the polymer-polyol is appropriate for preparing the photochromic coating products in the ophthalmology field.

10. A composition according to claims 5 to 8, wherein the composition is appropriate for preparing the photochromic coating products in the ophthalmology field.
